(19) United States
(12) Patent Application Publication
(10) Pub. No.: US 2015/0036100 A1
(43) Pub. Date: Feb. 5, 2015

(54) CONTACT LENS

(71) Applicant: LENSWISTA AG, Berlin (DE)

(72) Inventors: Martin Görne, Hamburg (DE); Thomas Kordick, Goldbach (DE)

(73) Assignee: LENSWISTA AG, Berlin (DE)

(21) Appl. No.: 14/004,760

(22) PCT Filed: Feb. 1, 2013
(86) PCT No.: PCT/EP13/00323

§ 371 Date: Sep. 12, 2013

(30) Foreign Application Priority Data
Feb. 1, 2011 (EP) 12000649.9
Feb. 1, 2013 (WO) WO2013083855

(51) Int. Cl. G02C 7/04; G02B 1/04

(52) U.S. Cl. CPC G02C 7/049; G02B 1/043
USPC 351/159.33; 351/159.73

(57) ABSTRACT

A hydrophilizingly coated silicone contact lens has a radial cross-section of the inner face (1), the rim portion contour of which is convex (7) between a point of inflection (6) and the outer edge.

For its manufacture, a silicone precursor is brought between a female and a male mold and is polymerized, and the polymerized contact lens is released from the mold by means of a liquid swelling same and is completed after a PECVD/CVD-coating without edge cutting.

The present application relates to a “soft” contact lens with excellent wearing properties.

Conventional contact lenses, e. g. those known from the German utility model publication G 87 10 765 U1, have a radially inner part made of a harder material, and a radially outer part made of a softer material. The inner surface is entirely concave and the outer surface entirely convex, i.e. both surfaces have a positive Gaussian curvature. This known lens is not satisfactory with regard to its wearing comfort.

It is also known to apply a hydrophilic coating to a contact lens made of poly(methyl methacrylate), PMMA (U.S. Pat. No. 5,080,924). Still, the wearing comfort of such lenses is not perceived as satisfactory.

The invention aims at providing a contact lens having good or even excellent wearing comfort, and a method for its manufacture.

This problem is solved by a contact lens made of silicone, wherein a radial cross section on the inner face has a rim region between a point of inflection and the outer edge in which the cross section contour is convex, in particular with a radius of between 0,1 and 10 mm. Because of this rim contour, the lens particularly readily slips onto the tear liquid film.

In embodiments, the contact lens has a surface layer made of a hydrophilic material auf, which further improves on the wearing comfort.

According to another aspect, the problem is solved by a process in which a silicone precursor material is brought in between a female and a male mold and is polymerised, and the polymerised contact lens is removed from the mold by means of a liquid swelling the contact lens and completed without edge cutting. Thereby the occurrance of a cutting edge, which might be perceived as irritating, is avoided.

In embodiments, the raw lens thus obtained is hydrophilized in a combined PECVD/CVD-process, whereby particularly thick coatings are achieved.

Further features of the invention are available from the subsequent description of embodiments in conjunction with the claims and the drawings. The invention is not limited to the described embodiments, but defined by the scope of the appended claims. In particular, individual features of embodiments of the invention may be realized in a different number or combination than in the examples explained hereunder. In the following explanation of embodiments reference is made to the appended drawings, which show:

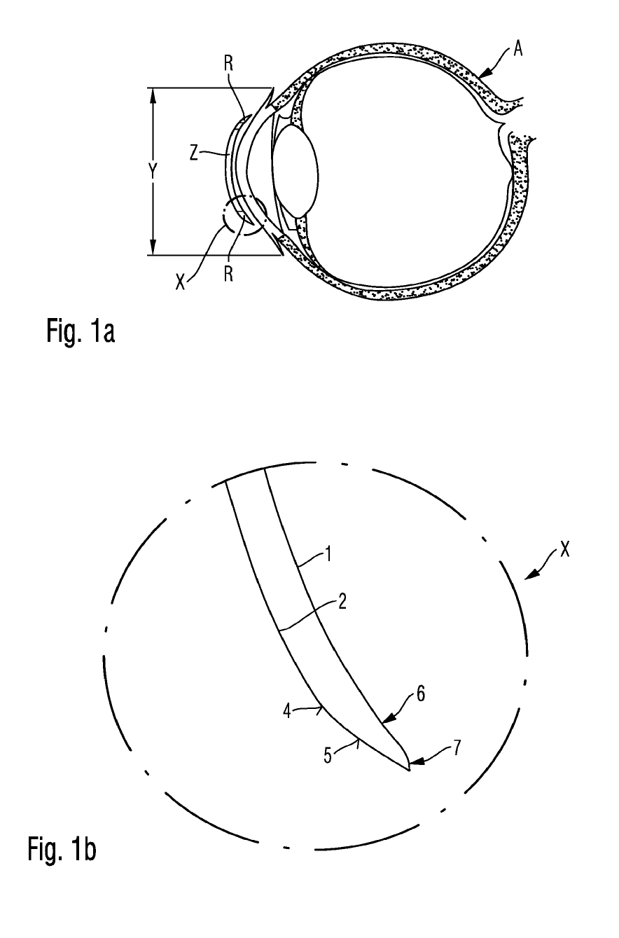

FIG. 1a a schematic cross-sectional view of a contact lens placed on the cornea of an eye,

FIG. 1b a schematic close-up view of a rim portion of the contact lies of FIG. 1a,

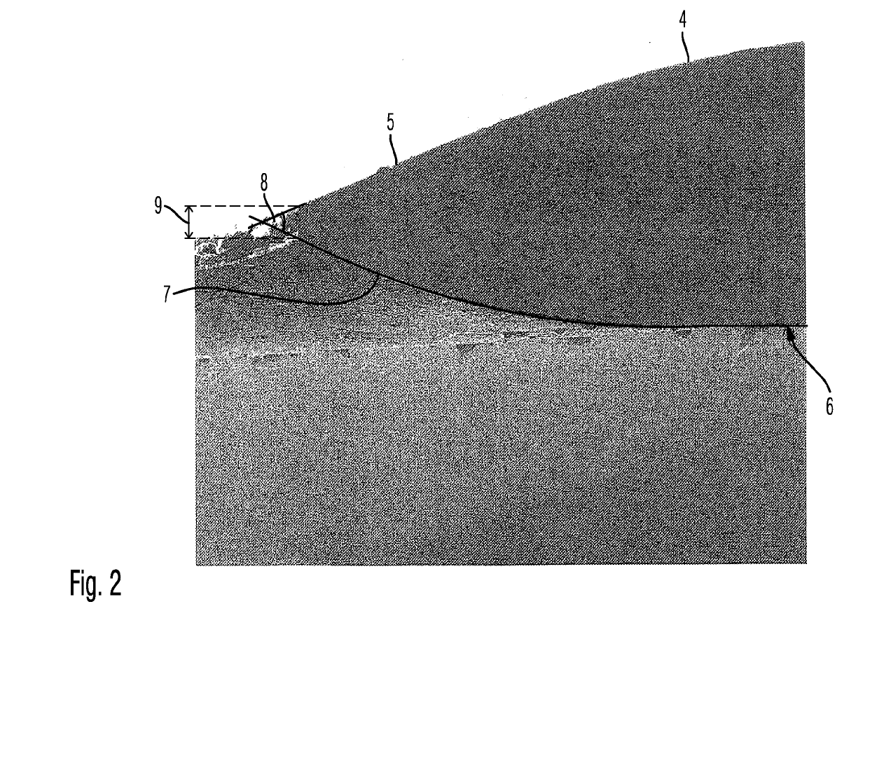

FIG. 2 an electron-microscopic image of the rim portion of the contact lens,

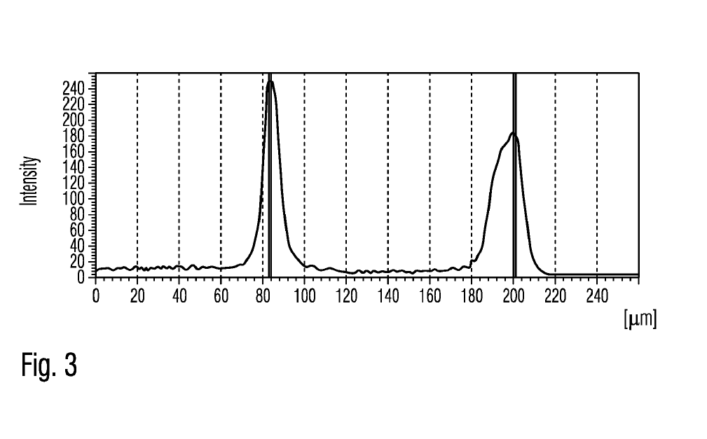

FIG. 3 a fluorescence diagram indicating a surface coating,

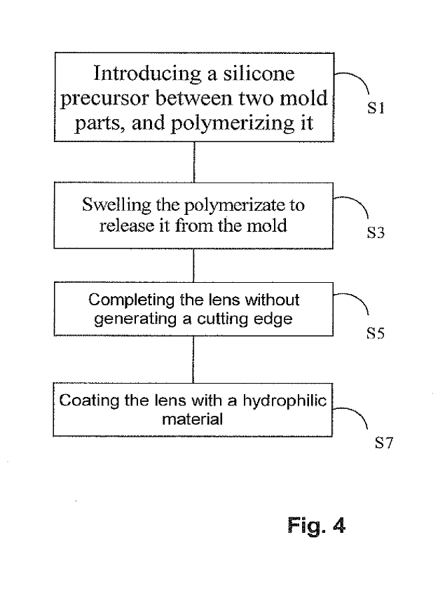

FIG. 4 a flow diagram for a manufacturing method of the contact lens according to the invention, and

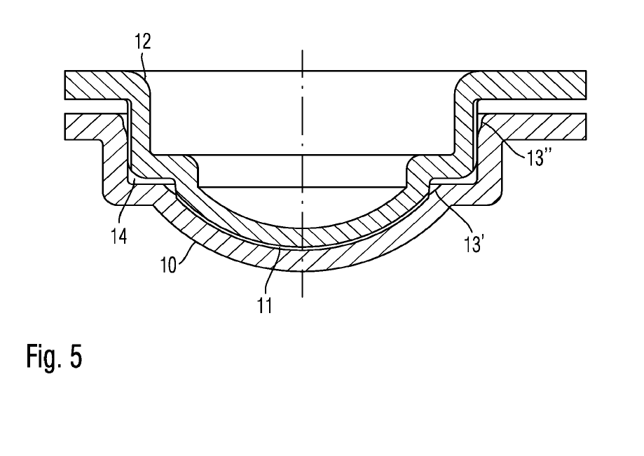

FIG. 5 a cross-sectional view of a molding apparatus suitable for the manufacturing according to FIG. 4.

The general shape of a contact lens is shown in Figures la and lb: The inner face 1 facing the cornea, which face, in use, floats on a film of tear liquid, is concave in its central part Z, namely rotationally symmetric-aspheric with a conus coefficient of about −0.1 to −0.5, thus somewhat elliptically pointed. In principle, this face also may deviate from the rotational symmetry if required by the physiological conditions. The outer face 2 of the lens is naturally convex with radius somewhat deviating from that of the inner face in magnitude, in order to provide the desired dioptric power. In the outer rim portion R, the curvatures or radii, respectively, deviate from the central values in the following manner: On the outer face, an annular part 4 with stronger (inward) curvature, thus smaller radius, is radially contiguous to the central portion. To this part, another may be outwards contiguous which is again less curved, conical (thus non-curved) or slightly outwardly (i.e. negatively) curved portion 5. In terms of magnitude, the curvature here is always less (i.e. the radius larger) than in the first mentioned transition region 4, i.e. the lens smoothly terminates.

The inner face 1 also has an annular region radially contiguous to the central region with the elliptical face, which, however, is less curved, thus more flattish, corresponding to a larger radius of curvature in this region. Herein, the radius of curvature in a sectional plane is meant, which plane contains the optical axis of the lens. The line formed by the inner face and the sectional plane forms a point of inflection 6, i.e. the curvature of the line first becomes zero and then positive. For the Gaussian surface curvature, this means a transition to negative values. To this region, the region 7 is contiguous, where the inner face of the contact lens approaches to the global tangential plane; here, the curvature in the main section perpendicular to the radial sectional plane is zero, so that the Gaussian surface curvature becomes zero and still further outside, in the immediate edge region, again transitions to positive values.

Between these two points (in the sectional plane) or lines (on the surface) of curvature inflection 6 and 7 there is a region in which the contact lens gradually lifts, when viewed radially from inner to outer region, from the cornea. This region is crucial for the wearing comfort. As recognized by the inventors, in this region there should neither be formed an overly sharp edge, which might interrupt the film of tear liquid present on the cornea or might even cut into the cornea; nor should the rim region have an outwardly pointed, protruding, strongly curved edge (“Skispitzen-Profil”), which might irritate the eyelid slipping onto it from outwards during blinking. Rather, the annular regions according to the invention, smoothly transitioning towards an outer edge free from any sharp edges, (see FIG. 2) achieve an unperturbed floating of the contact lens onto the tear liquid film and at the same time enable an unperturbed slipping of the eyelid onto the contact lens. It was found that the radius of the inner face, i.e. the inverse curvature, along the radial sectional plane, is for example between 0,1 and 4 mm, or above 0,5 mm on the one hand or/and below 2 mm on the other hand. The radial extension of the negatively curved area region may be 1 μm to 1 mm, for example more than 10 μm on the one hand or/and below 100 μm on the other hand. The outer edge itself may include, instead of one acute angle 8, two obtuse angles, between which an approximately cylindrical outer rim region 9 extends for e.g. 10-30 μm as discernible from FIG. 2.

In FIG. 3, a fluorescence diagram of a surface coating is shown, as maybe applied for hydrophilizing the per se hydrophobic silicone base material of the contact lens. The core part of the lens consists of poly(dimethylsiloxane) with a Shore-A hardness of 25. In this example, for the purpose of analysis an applied PAA-(poly acrylic acid) layer has been stained with the fluorescence dye Rhodamin 6G, and the depth extension of the fluorescence has been determined by confocal microscopy. As can be seen, the entire thickness (line width) of the PAA coating is several tens of μm. The lens thickness at the measurement position (line spacing) is 118 μm. The coating was made by PECVD followed by CVD. During the plasma coating phase the pressure ratio was changed from an initially prominent Argon excess (>10:1) towards a similarly prominent Argon deficiency (<1:10) near the end, at decreasing total pressure. This conditioning step was followed by an on-top-polymerisation of water-free acrylic acid from the vapour phase at its normal vapour pressure, without action of a plasma and without the presence of a noble gas. The initially plasma-enhanced provided layer had a thickness of 20-30 nm, i.e. in the order of magnitude of about one part per thousand of the entire layer thickness. Such layers have optically as well as physiologically excellent properties due to the strong hydrophilicity. The contact angle of the applied layer in water is less than 10° and typically 2-5°. The beneficial shape effects of the according to the invention are targeted supported by this treatment of the material.

In FIG. 4, a flow diagram of a process according to the invention is shown. Initially, a female and a male mold are provided, and a precursor material for poly (dimethylsiloxane) is brought into female mold, closed with the male part, and polymerized at a temperature between 15° C.-160° C. for 12-720 min. S1 (molding). After the closing, the mold parts are rotated with respect to one another by 180° or another angle sufficiently large)(>20°, as long as the reaction mixture is just viscous (over 1000 cP; typically ca. 4000 cP), so that excess silicone is reliably separated and displaced into the annular space between the mold parts. In this separation, the rim contour described above is created due to the effect of the surface energy, allowing the dispensing with an edge cutting step or other edge treatment creating a cutting edge (e.g. punching). For demolding, the contact lens is partially swollen with an alkane such as e.g. hexane or another nonpolar or little polar solvent S3, so that it releases S5 without mechanical action from the mold and the manufacturing parts. The dipole moment of the solvent should not be more than 0,2 Debye to this end. In support, an ultrasonic bath may be employed. The starting material may be a liquid 2-component silicone by NuSil with a DK-value of above 700 barrer. If desired, the lens is transferred after evaporating the solvent in a vacuum into a coating chamber and initially is cleaned with an Argon plasma (ca. 1 min) and prepared. Then, a phase S7 with a slight Argon excess 1:1 to 2:1 (partial pressure ratio) with respect to acrylic acid vapour follows, the latter obtained from water-free acrylic acid. Exemplary pressures are 0,03 Torr for Argon and 0,015 Torr for acrylic acid. This phase, which takes 10 to 90 min, is followed by an about ten-minute phase at closed Argon supply and further reduced acrylic acid pressure (ca. 0,1 mTorr). Then, the plasma generator is switched off, and the lens is exposed at room temperature to the saturation pressure of the acrylic acid, until a turbidity indicates the completion of the process (about 5 min). The contact lens is watered for 24 h in a hydrophilic liquid, for example in isotonic saline solution, to remove potential remainders of the coating agent, and is steam sterilized at above 120° C.

In FIG. 5, a two-part mold is shown, which is suitable for carrying out the above described process. The lower, female part 10 initially accommodates the reaction mixture and is then closed with the upper, male part 12, wherein a space 11 filled with the reaction mixture remains between them. The lower part 10 has chamfers 13′, 13″ facilitating the fitting together and separating the mold parts 10 and 12. The annular space is indicated as 14.

From the proceedings of the process an irregularity of the outer results insofar as it deviates from an exact circle line, other than known e.g. from punched lens contours. Because also the cornea never has exactly regular contours, this deviation from an ideal shape not only is not detrimental, but even has beneficial effects on the wearing comfort. The amount of the irregularity may be quantified by assigning, by calculation, an ideally approximating circle line to the projection of the outer rim, according to the criterion of a minimum sum of the squared deviations. The, the average square deviation is a measure of the irregularity, and is at least 5000 μm² (converted to magnitudes: about 1% of half the lens diameter), but in embodiments may be more than 1000 μm² or more than 10000 μm².

The contact lenses formed according to the invention may be used as cover lenses, i.e. with or without refractive power for physically protecting the cornea from irritations. This may be useful as a flanking, itself non-therapeutic measure for a medicinal-therapeutic eye treatment.

In the subsequent claims, “mainly consisting” is understood as amass proportion of more than 50%, in particular of more than 90% up to entirely. “Curvature” is in each case the inverse radius of curvature, i.e. the radius of the approaching circle, wherein the sign is positive for convex surfaces and is negative for concave surfaces. The Gaussian surface curvature is the product of the two principal curvatures, thus is negative when both the principal curvatures have different signs (saddle surface), and is zero when one or both principal curvatures are zero (e.g. cylinder and conus surface).

The skilled person will realize that deviations from the embodiments described above are possible without leaving the scope of protection of the appended claims.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. A silicone contact lens, having a radial cross-section on an inner face of the contact lens that includes a rim region between a point of inflection and the outer edge, in which the contour of the cross-section is convex,
said contact lens comprising a hydrophilizing surface coating having the water contact angle of less than 10°.

22. The contact lens of claim 21, wherein the minimum radius of the convex contour of the cross-section is in the range 0.1 mm-10 mm.

23. The contact lens of claim 22, wherein the hydrophilizing layer consists mainly of (meth)acrylic acid units.

24. The contact lens of claim 22, wherein the hydrophilizing layer is thicker than 1 gm.

25. The contact lens of claim 21, wherein the silicone is poly(dimethylsiloxane).

26. The contact lens of claim 21, wherein the rim region of the contact lens has a width in the range of 1 μm to 1 mm.

27. The contact lens of claim 21, wherein the outer edge of the contact lens has an irregularity, wherein a circle line ascribed to the outer edge according to the criterion of least mean squared deviations has an average squared deviation of at least 5000 μm².

28. A method of manufacturing a silicone contact lens, wherein a female mold part and a male mold part are provided, and a silicone precursor material is introduced between the mold parts and is polymerized between the mold parts, said method comprising:
releasing the polymerized contact lens form the mold using a liquid swelling the contact lens without generating a cutting edge; and
hydrophilizing the polymerized contact lens in a combined PECVD/CVD-process.

29. The method of claim 28, wherein the contact lens is coated with cross-linked (meth)acrylic acid units.

30. The method of claim 28, wherein a first coating step occurs in a low-pressure plasma.

31. The method of claim 30, wherein a subsequent coating step occurs from the gas phase without the action of a plasma.

32. The method of claim 28, wherein a non-polar liquid is used for releasing the contact lens from the mold, a dipole moment of which is less than 0,2 Debye.

33. The method of claim 28, wherein the released contact lens is treated with a polar liquid, the dipole moment of which is more than 1 Debye.

34. The method of claim 28, wherein, while the reaction mixture is still liquid, the mold parts are rotated with respect to one another in order to separate the part of the reaction mixture intended for forming the contact lens from excess material.

35. The method of claim 28, wherein the contact lens comprises a hydrophilizing surface coating, the water contact angle of which is less than 10°.

36. A contact lens made according to the method of claim 28.

37. The contact lens of claim 21, wherein the minimum radius of the convex contour of the cross-section is more than 0.5 mm.

38. The contact lens of claim 21, wherein the rim region of the contact lens has a width in the range of 0.01 mm to 0.1 mm.

39. The contact lens of claim 21, wherein the contact lens comprises a bandage contact lens.

40. The method of claim 28, wherein the contact lens comprises a bandage contact lens.
